(19) United States
(12) Patent Application Publication
(10) Pub. No.: US 2009/0312567 A1
(43) Pub. Date: Dec. 17, 2009

(54) SYSTEM AND METHOD FOR SUPPRESSING SUBLIMATION OF MATERIALS DURING CHEMICAL TRANSFORMATION AT HIGH TEMPERATURES

(76) Inventor: Peter HRNCIAR, Hamden, CT (US)

Correspondence Address: WILMERHALE/BOSTON, 60 STATE STREET, BOSTON, MA, 02109, US

(21) Appl. No.: 12/137,308

(22) Filed: Jun. 11, 2008

(51) Int. Cl. C07F 11/00; B01J 19/00

(52) U.S. Cl. 556/60; 422/198

(57) ABSTRACT

An apparatus for use in reactions of materials with a propensity for sublimation at high temperatures has a central chamber that is immersed in a reaction vessel, attached with an air tight joint. The chamber is surrounded by a cooling jacket filled with a circulating medium, the temperature of which is adjusted below the temperature of the solution of reactants. The central chamber is immersed into the mixture and is partially filled with a liquid. This liquid is cooled by the medium circulating in the cooling jacket. The cooling ensures that the liquid filling the tube has a lower temperature than the mixture, preventing sublimation of the materials.

### FIELD OF THE INVENTION

This application relates to systems and methods for inhibiting the sublimation of reactants during a high temperature chemical reaction.

### BACKGROUND

Reactions can be propelled by heating a solvent for one or more reaction components during a chemical process in which at least one component has a propensity to sublime at elevated temperatures. This propensity of a material to sublime upon heating will cause the material to escape from a reaction vessel, possibly preventing a chemical process from proceeding and rendering chemical transformations of such materials difficult.

One could try to manually return sublimed material to a reaction vessel but this process might require an operator to open the reaction system and might permit an entry of air or impurities, causing decomposition of air sensitive materials or other contamination of reactants or products. Rapid sublimation of reagents slows down a reaction process as it decreases the effective concentrations of materials available for the chemical transformation.

### SUMMARY

The problem of sublimation of reactants in a vessel can be ameliorated by using the systems and methods disclosed herein. A tube, immersed in an air tight reaction vessel, partially fills with the reactants, e.g., in a solution form, creating a layer of cooler liquid that isolates the boiling or heated mixture of reactants from the upper levels of the apparatus. The isolating layer of cooler liquid is created by a medium circulating in a cooling jacket that surrounds the tube immersed in the heated solution. Such a configuration enables heating of the mixture of reactants while inhibiting the escape of materials with a high propensity for sublimation.

The systems disclosed herein represent an apparatus for use in reactions of materials with a propensity for sublimation at temperatures at which processing is desired. The apparatus includes a central chamber that is immersed in a reaction vessel, attached with an air tight joint. The chamber is surrounded by a cooling jacket filled with a circulating medium (e.g., liquid or gas), the temperature of which is adjusted below the temperature of the solution of reactants. The central chamber is immersed into a heated mixture of reactants placed in the vessel and is partially filled with a liquid. This liquid is cooled by the medium circulating in the cooling jacket. The cooling causes the liquid filling the tube to have a lower temperature than the mixture, inhibiting sublimation of the materials.

The present embodiments enable chemical transformations of materials with high propensity for sublimation at high temperatures and are applicable to a variety of smaller-scale laboratory experiments or large scale industrial processes.

### BRIEF DESCRIPTION OF THE DRAWINGS

Embodiments of the systems and methods disclosed herein will be more apparent upon the consideration of the following detailed description, taken in conjunction with the claims and the following drawings, in which like references refer to like parts throughout, and in which:

FIG. 1 is a schematic of a central chamber positioned in a reaction vessel, wherein an elongated section of the central chamber has bulbous sections, according to an embodiment of the present teachings.

FIG. 2 is a schematic of the central chamber, wherein the elongated section has a circular cross-section, according to an embodiment of the present teachings.

### DETAILED DESCRIPTION

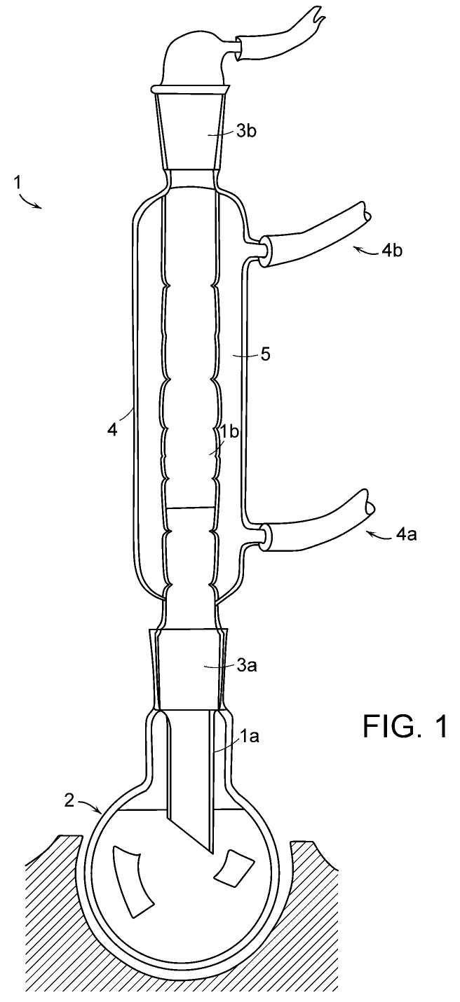

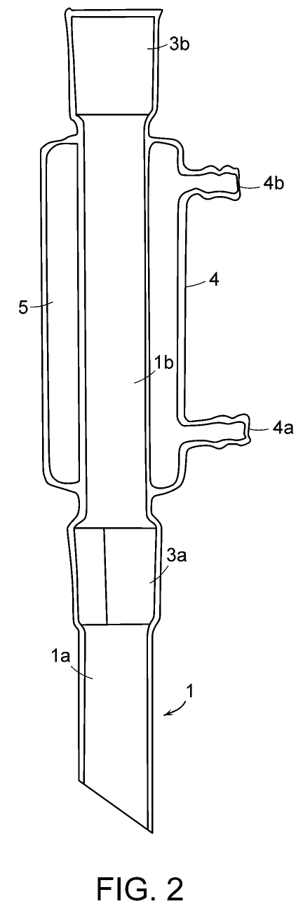

Referring to FIGS. 1 and 2, an exemplary system has a reaction vessel 2 for holding a liquid being processed, a central elongated chamber 1 extending into the vessel 2, and a cooling jacket 4 surrounding a portion of the central chamber 1.

The central chamber 1 has a conduit with a protruding section 1a extending into an open end of the reaction vessel 2 and an elongated section 1b located above the reaction vessel 2. The central chamber 1 is equipped with two joints: a bottom joint 3a and a top joint 3b. The bottom joint 3a attaches the central chamber 1 into a reaction vessel 2 in an air-tight manner and the top joint 3b allows attachment of a gas inlet or outlet. The protruding section 1a of the central chamber 1 extends a sufficient length into the liquid in order to permit liquid from the reaction vessel 2 to enter the chamber 1. For example, the sufficient length can be approximately at least one quarter, at least one third, or at least one half of the distance between the lower end of the bottom joint 3a and the bottom of the reaction vessel 2, depending in part on the shape of the vessel and how full it is.

In some embodiments, the end of the protruding section 1a of the central chamber 1 is cut in an approximately 35° to an approximately 65° angle to create a larger opening than the diameter of the central chamber.

The elongated section 1b of the central chamber 1 can be a straight cylindrical tube, having a substantially circular cross section, as shown in FIG. 2, or it can contain bulbous sections of various diameters, as shown in FIG. 1, or it can have other suitable shapes, such as curved or serpentine. The elongated section 1b should be sufficiently long to accommodate potential variations in the level of liquid in the tube.

The attachment of the central chamber 1 to the reaction vessel 2 is air tight. On a smaller scale, such a connection can be accomplished by using ground joints or screw cap joints with an insulating o-ring. On a larger scale, the protruding section 1a can be permanently appended to the reaction vessel 2. Other types of air tight attachments of the protruding section 1a and the reaction vessel 2 can be used.

The liquid can be a solution of a solvent and a solid. The solid can be any substance that readily sublimes at temperatures at which processing is desired, for example, metal carbonyls such as chromium hexacarbonyl, molybdenum hexacarbonyl, and tungsten hexacarbonyl, and iodine, ammonium chloride, and bis(cyclopentadienyl)nickel(II).

The central chamber 1, as described above, can be placed in a cooling jacket 4 that covers a part of the elongated section 1b of the central chamber 1, such as more than one-half of the length. The cooling jacket 4 would typically be situated close to the bottom joint 3a, although it could be anywhere in contact with elongated section 1b. The cooling jacket 4 can be equipped with an inlet 4a for a coolant 5 and an outlet 4b as shown in FIG. 1. The temperature of the coolant 5 can be adjusted based on the temperature of the reaction mixture and sublimation propensity of the reactants or liquids contained within the reactant vessel 2. The temperature of the coolant 5 can vary depending on the systems and the reactions. The coolant 5 can be at a temperature such that when in thermal communication with the liquid, it reduces the temperature of the liquid to a level below the sublimation temperature of the solid dissolved in the liquid. The sublimation temperature of a solid can vary depending on pressure, and can vary in an anisotropic manner if the solid is dissolved in a solvent or mixed with other materials. If the solid is dissolved in a solvent, forming the liquid or solution, the sublimation temperature of the solid can vary depending on the boiling point of the solvent. Accordingly, the sublimation temperature of a component refers to the temperature at which the component sublimes under the then-current conditions. For certain reactions, the sublimation temperature can range from between 20° C. and to about 100° C. and the temperature of the coolant can be at least 50° C. below the temperature of the mixture inside the reaction vessel 2. The coolant 5 can be a liquid, for example, water or another liquid coolant or a gaseous coolant. The temperature of the coolant 5 can be maintained using a variety of laboratory cooling/heating circulators or other equipment. For example, a JULABO (Seelbach/Black Forest, Germany) PRESTO® LH45 circulator provided by a number of vendors, including ThermoFisher (Waltham, Mass.) or Chemglass (Vineland, N.J.), can be used.

During the reaction process, a sufficient amount of liquid can be added to the reaction apparatus to fill not only the reaction vessel 2, but also the entire protruding part of the chamber 1a and a part of the 1b section of the central chamber above the bottom joint 3a. The level of the liquid in the central chamber 1 should be in contact with the cooling jacket 4 containing the coolant 5 and can rise a substantial amount about the cooling jacket 4, for example, about 1 cm to about 4 cm above the cooling jacket 4.

### EXAMPLE

One possible embodiment of the present invention is constructed as follows. The central chamber of length 37 cm with external diameter of 16 mm and internal diameter of 12 mm is equipped with an outer standard taper joint (24/40) for the top joint and inner standard taper joint (24/40) for the bottom joint. The shorter length of the tube extending from the inner joint (the protruding section) is about 4 cm long and the longer length is about 6 cm. The length of the tube between the top and bottom joints is about 27 cm. The part of the chamber between the joints is inserted into a jacket with internal diameter of about 3 cm and external diameter of about 3.4 cm. The distance between the jacket and the bottom joint and the top joint is about 1.8 cm. The jacket has an inlet and an outlet for a coolant situated about 2 cm from the top and bottom of the jacket, respectively. The apparatus is constructed from PYREX® laboratory glassware.

The above described apparatus was employed in an experiment in which chromium hexacarbonyl, a highly subliming solid, was converted into toluene chromium tricarbonyl under the following conditions. Toluene (6 mL) chromium hexacarbonyl (2 g) and 0.5 mL of acetic acid were placed into a 250 mL, single neck, round bottom flask. The above described apparatus was attached to the flask, using standard vacuum grease as a lubricant for the taper joints. Trans-decahydronaphthalene (solvent) was poured into the flask through the outer joint of the apparatus attached to the flask until the solvent filled the flask and a portion of the central chamber so that the level of liquid raised about 2 cm into the jacketed section. The outer joint of the apparatus was attached to an adapter for outlet of carbon monoxide produced in the reaction. All of the reagents and solvent were free of oxygen and the experiment was carried out under exclusion of air under nitrogen gas. The cooling jacket of the apparatus was filled with coolant, in this case water heated to 80° C. During the experiment, the temperature of the coolant was maintained between about 75° C. and about 80° C. The reaction vessel was heated until the liquid inside the vessel started to boil. The reaction was maintained at this temperature for approximately 4 hours. The mixture was cooled to −10° C. at which the product crystallized as yellow solid, which was filtered and dried.

It will be appreciated that the scope of the methods and systems is not limited to the above-described embodiments, but rather is defined by the appended claims, and these claims will encompass modifications of and improvements to what has been described. For example, embodiments have been described for high temperature reactions. However, systems and methods can be implemented for lower temperature reactions where the sublimation point of the solid of interest occurs at a low temperature.

What is claimed is:

1. A method comprising:
providing a solution into a processing apparatus that includes:
a vessel, and
a conduit extending into the vessel with an air tight seal,
the solution including a component that sublimes at a sublimation temperature during the processing;
the providing being performed such that the solution extends into the conduit;
heating the solution in the vessel to a temperature equal to or greater than the sublimation temperature of the component; and
circulating a coolant through a cooling jacket to reduce the temperature of the solution in at least part of the conduit, the coolant having a temperature such that the portion of the solution cooled by the cooling jacket is below the sublimation temperature of the component, thereby inhibiting the component from subliming and escaping the vessel during the heating.

2. The method of claim 1, further comprising, after the heating, cooling the vessel to obtain a solid end product.

3. The method of claim 1, wherein the coolant comprises a liquid.

4. The method of claim 1, wherein the coolant has a temperature at least 50° C. lower than the temperature of the solution.

5. The method of claim 1, wherein the component includes a chromium hexacarbonyl.

6. The method of claim 1, wherein the conduit is substantially elongated and has an outlet at an end opposite an end extending into the vessel.

7. A method comprising:
providing a solution of a product that sublimes at a sublimation temperature in a reaction vessel fluidly coupled to a chamber having a cooling jacket;
heating the solution in the reaction vessel to a temperature greater than the sublimation temperature; and
while heating, using the cooling jacket to cool a portion of the solution so that the cooled solution has a temperature lower than the sublimation temperature of the product.

8. An apparatus comprising:
a reaction vessel;
a chamber in fluid communication with the reaction vessel including:
a conduit having a first potion extending through an air-tight seal, and second portion extending outside the reaction vessel;
a cooling jacket enclosing at least some of the first a portion of the conduit; and
a solution of a product that sublimes at a sublimation temperature in the reaction vessel,
wherein the solution contained within the reaction vessel extends into the first and second portions of the conduit such that the solution is in thermal communication with the cooling jacket, and
wherein the temperature of the solution in thermal communication with the cooling jacket is lower than the sublimation temperature,
the cooling jacket inhibiting the product from escaping the reaction vessel in a gaseous form during a processing in which the vessel is heated to a temperature greater than the sublimation temperature.

9. The apparatus of claim 8, wherein the first portion is substantially disposed within the solution.

10. The apparatus of claim 9, wherein substantially disposed includes at least one half of the depth of the reaction vessel.

11. The apparatus of claim 9, wherein substantially disposed includes at least one quarter of the depth of the reaction vessel.

12. The apparatus of claim 8, wherein the cooling jacket has a circulating fluid at a desired temperature.

13. The apparatus of claim 8, wherein the conduit has an end away from the vessel with a top joint that has a seal and an outlet.

14. The apparatus of claim 8, wherein the cooling jacket covers at least one half of the second portion.

15. The apparatus of claim 8, wherein the elongated chamber is substantially cylindrical.

16. The apparatus of claim 8, wherein the elongated chamber has a plurality of bulbous sections.

17. The apparatus of claim 8, wherein the elongated chamber is about 37 cm in length, the first portion is about 6 cm in length and the second portion surrounded by the cooling jacket is about 27 cm.

18. An apparatus comprising:
a reaction vessel;
an elongated chamber in fluid communication with the reaction vessel including:
a top joint,
an air tight bottom joint,
a protruding member extending below the bottom joint, wherein the first section is substantially disposed within the reaction vessel a sufficient amount such that the protruding member extends into the contents of the reaction vessel when filled to a typical level, and
an elongated section, extending from the bottom joint to the top joint;
a cooling jacket enclosing a portion of the elongated section;
the vessel and elongated chamber configured such that if a solution of a product that sublimes at a sublimation temperatures is provided in the reaction vessel, the solution can extend into the elongated chamber and be cooled by the cooling jacket to inhibit sublimation of the product.
